(19) United States
(12) Patent Application Publication
(10) Pub. No.: US 2006/0207673 A1
(43) Pub. Date: Sep. 21, 2006

(54) Vacuum insulated assured flow piping

(76) Inventors: John V. O'Brien, Shrewsbury, MA (US); James Runyan, Conroe, TX (US)

Correspondence Address: GAUTHIER & CONNORS, LLP, 225 FRANKLIN STREET, BOSTON, MA, 02110, US

(21) Appl. No.: 11/084,662

(22) Filed: Mar. 18, 2005

(51) Int. Cl. F16L 11/00

(52) U.S. Cl. 138/114; 138/148; 138/149

(57) ABSTRACT

An assured flow conduit has an inner conduit having an inner diameter sized to accommodate a flow of warm fluid and an outer diameter. The inner conduit is formed from a material having a low hydrogen content. An outer conduit encloses the inner conduit and has an inner diameter larger than the outer diameter of the inner conduit and defines a space there between. An insulating sleeve is interposed between the inner conduit and the outer conduit and within the space, wherein the sleeve is formed from an aerogel.

### BACKGROUND

1. Field of the Invention

This invention relates generally to transporting warm, high viscosity liquids in pipes and is concerned in particular with an improved apparatus for the assured flow of such liquids.

2. Description of the Prior Art

One of the major problems confronting the oil industry is the transport of heavy crude oils in pipelines. The fluids are highly viscous and contain asphaltines and other components that can precipitate and coat the wall of the transporting pipe, leading to its ultimate blockage.

Pipelines for transporting heavy crude oil are located in remote locations and in harsh environmental conditions, such as above ground, where the ambient temperature can drop to −30° F., or under water, where the water temperature may be within a few degrees of freezing.

One approach for providing assured flow in such pipelines is diluting the oil with a light naphtha to render them flowable. But after transport through the pipeline, the naphtha has to be separated from the oil, and returned to the oil's source through a separate pipeline for storage and recycling. This results in extensive additional equipment and the associated energy consumption for the naphtha separation and pumping.

Another approach has been the installation of multiple heating stations and along the length of the pipeline to keep the temperature of the oil at a level where it maintains its reduced viscosity. The heaters, however, have a high fuel energy consumption, which results in that much less energy available for export from the site.

In other applications where a natural gas stream is transported from a well to an offshore platform, the gas stream may cool to a point where hydrate formation occurs, resulting in complete blockage of the pipeline. The blockage is cleared by “pigging”, whereby a device is inserted into the pipeline to travel to the blockage and mechanically clear it. This can result in several days of production loss and is undesirable for the pipeline operator.

Pipe-in-pipe constructions with an insulating medium between an inner and outer pipe are well known. One example of an insulating medium is polyurethane foam, which has a reasonable thermal efficiency, is mechanically strong, and capable of working in a temperature range −328° F. to 302° F. Polyurethane foam, however, is bulky and requires relatively large volumes in order to achieve low U-values. For example, a six inch thickness of foam would be necessary to achieve a U-value of about 0.3 W/m²K.

Another example of a pipe-in-pipe with an insulating medium are the IZOFLEX™ insulated pipes available from ITP Interpipe of Houston, Tex. IZOFLEX™ is a proprietary silica based microporus insulation material. The space between the inner and outer pipes is entirely occupied by the IZOFLEX™ insulation. A U value of 0.55 W/m²K is claimed for this system when handling a warm oil.

Another approach is to provide the pipeline with vacuum jacketed piping with a highly effective insulation. One example is vacuum jacketed piping employing a pipe-in pipe design, with multiple layers of insulation, such as Mylar or aluminum foil, wrapped around the outer surface of the inner pipe. The space between the pipes not occupied by insulation is maintained under a “hard” vacuum, below the level of 0.001 Torr. However, this technology is mostly used in the cryogenics area, it is not applicable to the handling of warm fluids. The foil used in the multiple layers of insulation fuses at warm temperatures. Maintaining a “hard” vacuum in the annulus is difficult because of out-gassing of hydrogen from the steel in the inner pipe at warm fluid temperatures. Carbon steel pipes typically contain hydrogen at about 3 to 5 parts per million by weight. Reducing the hydrogen content in carbon steel to less than one part per million by heat treating is well known.

For the purposes of this application, we define “warm fluid” as a fluid with a temperature above the ambient temperature of the environment through which the fluid is transported.

Another example of a highly effective insulation used in a vacuum jacketed piping wraps the inner pipe with alternating layers of foil and so-called “scrim” to minimize radiant heat losses. Maintaining the vacuum between inner and outer pipes is still an issue. A gettering material, such as a carbide, is used to absorb the out-gassed hydrogen over time. But the limited space between the insulation and the outer pipe make it difficult to include adequate gettering material.

Aerogels are a solid material with nanometer-scale pores that are typically made from silica. The nano-scale lattice structure and pores create a reduced mean free path for gas molecules thereby reducing energy and mass transport. As aerogel has a very low thermal conductivity, they make an excellent thermal insulator. Aerogels are highly porous, constituting 90% to 99% voidage and have a density ranging from 6 to 9 pounds per cubic foot. Furthermore, loading an aerogel with carbon reduces its opacity and thermal conductivity.

Operating an aerogel under vacuum also reduces its thermal conductivity. Table 1 shows data published by Lawrence-Berkley National Laboratory on the effect of air pressure on the thermal conductivity of a silica based aerogel opacified with carbon black, at 20° C.

TABLE 1

| Pressure | Thermal Conductivity |
|---|---|
| (Torr) | (mW/m²K) |
| 750 | 13.5 |
| 100 | 6.0 |
| 10 | 4.5 |
| 1 | 4.5 |
| 0.01 | 4.5 |

Until recently, aerogels were primary manufactured in individual beads suitable for insulating cryogenic tanks for the storage of refrigerated liquids such as nitrogen and oxygen. Aerogels now can be manufactured in flexible blankets of various thicknesses, widths, and lengths.

### SUMMARY OF THE INVENTION

In one aspect of the present invention, an improved design for an assured flow conduit that has a highly effective resistance to heat loss has an application of an aerogel blanket material in an evacuated environment. An inner conduit is sized to accommodate a flow of warm fluid. The inner conduit is formed from a material having a low hydrogen content, preferably less than about 3 parts per million by weight, and more preferably less than about 1 part per million by weight. An outer conduit encloses the inner conduit and defines a space there between. An insulating sleeve formed from aerogel is interposed between the inner conduit and the outer conduit and within the space. The aerogel has a thermal conductivity of about 13 milliwatts per meter per degree Kelvin. The space is configured to be evacuated initially to a pressure of about 0.01 Torr and to maintain a low settle out pressure of preferably less than about 100 Torr and, more preferably, less than about 50 Torr. The temperature of the warm fluid is greater than the environment in which the conduit is installed and could range from about 32° F. to about 390° F. The warm fluid may be a heavy oil or a wet natural gas. The warm fluid may be a saturated steam.

In another aspect of the present invention, a method of transporting a flow of warm fluid includes providing an inner conduit having an inner diameter sized to accommodate a flow of warm fluid and an outer diameter, the inner conduit being formed from a material having a low hydrogen content. An outer conduit enclosing said inner conduit is provided and has an inner diameter larger than the outer diameter of the inner conduit and defining a space there between. An insulating sleeve is provided and interposed between the inner conduit and the outer conduit and within the space, wherein the sleeve is formed from an aerogel. A pressure within space is reduced to an evacuated level. The pressure is permitted to rise to a settle-out level.

Advantages of the present invention include providing an effectively insulated pipe with a low U value that can by utilized to for the handling of warm fluids to save energy by reducing reheat requirements. Greater fluid flow is possible because of reduced hydrate formation and asphaltine and wax deposition, which reduces pressure drop and the possibility of blockage. The pipe remains effectively insulated even when the pressure within the space rises to near atmospheric and atmospheric levels.

### BRIEF DESCRIPTION OF THE DRAWINGS

FIG. 1 shows a perspective view of part of an assured flow fluid transportation system with the layers sectioned at different lengths; and

FIG. 2 shows a cross section of an assured flow fluid transportation system.

### DETAILED DESCRIPTION

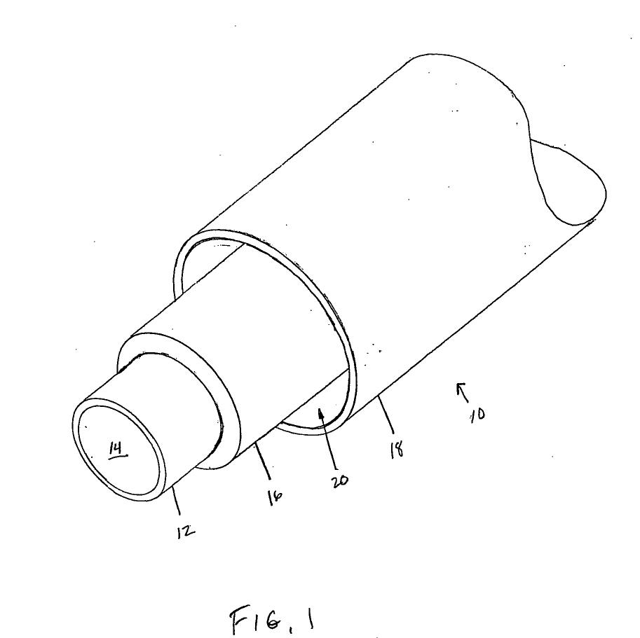

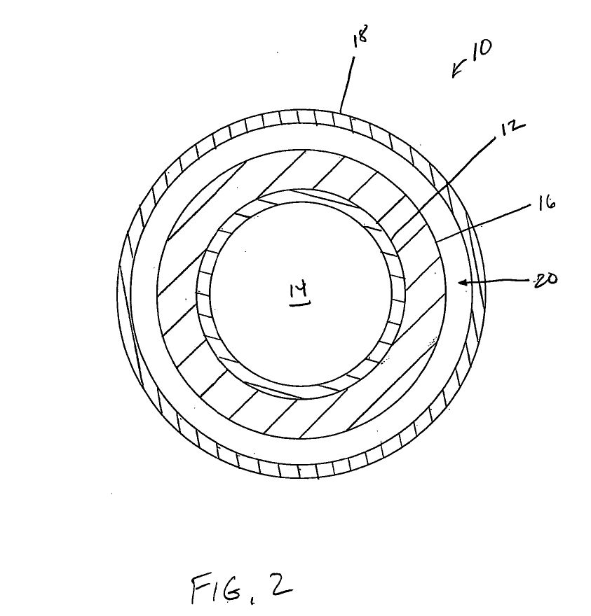

Referring to FIGS. 1 and 2, an example of an assured flow piping system 10 is shown. An inner pipe 12 carries a warm fluid 14. A layer of aerogel insulation 16 is wrapped around the inner pipe 12. An outer pipe 18 encloses the inner pipe 12 and aerogel insulation 16 and forms a ring-shaped space 20 between the inner pipe 12 and the outer pipe 18. When system 10 is installed, the space 20 is evacuated to a hard vacuum. Over time, the pressure in space 20 slowly rises to a low settle-out pressure, described in more detail below.

Inner pipe 12 is formed from steel having a low hydrogen content. The hydrogen content is controlled by the manufacturer of the inner pipe, usually by heat treating after the pipe is drawn. Preferably, pipe 12 has a hydrogen content of less than about 3 parts per million by weight. More preferably, pipe 12 has a hydrogen content of less than about 1 part per million by weight.

Outer pipe 18 may also be formed from the same low hydrogen content steel used for inner pipe 12, but the hydrogen content of outer pipe 18 is much less important than that of inner pipe 12. Outer pipe 18 typically operates at a temperature close to the environment in which system 10 is installed, which causes less hydrogen out gassing than the operating temperature of inner pipe 12, which is typically close to the temperature of warm fluid 14.

Aerogel insulation 16 is formed from blankets (not shown) of aerogel insulation wrapped around inner pipe 12. In one example, insulation 16 is formed from 0.25 inch thick blankets of Spaceloft™ AR5103 silica aerogel, which has a thermal conductivity of about 13 milliwatts per square meter per degree Kelvin and is available from Aspen Aerogels, Inc., of Northborough, Mass.

When warm fluid 14 flows through the inner pipe 12, the carbon steel forming pipe 12 operates at or near the temperature of fluid 14. This causes the hydrogen in the steel to diffuse outwards. Some diffuses into the warm fluid 14, depending on the partial pressure driving force between the hydrogen in the steel and the fluid 14, while the remainder diffuses into space 20, which contains the insulation 16. The outer pipe 18 is at the ambient environmental temperature and sees little hydrogen diffusion. What hydrogen is emanated flows both to the atmosphere and the space 20.

When installed as part of a pipeline, for example, space 20 is evacuated to a moderately hard vacuum of less than about 0.01 Torr during assembly. The pressure increases over time and, ultimately, the maximum pressure in space 20 depends on the amount of gas diffused out from the inner pipe 12 and the outer pipe 18. Aerogel insulation 16 is inert silica, for example, and has no degassed components. Any carbon used in the insulation 16 also does not degas. There are no other materials in space 20 to serve as a source of degassed hydrocarbons. Any hydrogen diffused from inner pipe 12 into space 20 fills the free space the void space in the insulation 16 and the free space between the outer surface of insulation 16 and the inner surface of outer pipe 18.

The settle out pressure in the space 20 can be limited in the design process by choosing the hydrogen content of the steel of the inner pipe 12, and to a lesser extent, outer pipe 18, the wall thickness of the inner pipe 12, the dimensions of space 20, the thickness of insulation 16, and estimating the average temperature in space 20.

In one example of system 10, inner pipe 12 has a nominal diameter of 6 inches (schedule 40) and is formed from steel with a hydrogen content of about 1 part per million by weight, outer pipe 18 has a nominal diameter of 10 inches (schedule 10), and 4 layers of Spaceloft™ AR5103 aerogel blanket are wrapped around inner pipe 12, making insulation 16 one inch thick. A calculation of the rate of pressure rise in space 20 over the operating life of this example shows the time taken to asymptotically approach the settle out pressure is about 10 years, while half this pressure is reached in one year. Provided that no leaks are developed into space 20, the settle out pressure should not be exceeded over the extended operating life of system 10.

The design parameters of system 10 can thus be manipulated to result in a low settle-out pressure under which conditions aerogel insulation 16 develops and maintains its high resistance to heat loss to the surroundings from the warm flowing fluid 14. For the purposes of this application, we define “low settle-out pressure” as preferably less than about 100 Torr and more preferably less than about 50 Torr.

In general, for pipes in the nominal 4 to 24 inch range, one option is to make the outer pipe 4 inches larger diameter than the inner pipe. This provides adequate space for the insulation 16 and also, adequate remaining free space in space 20 for ensuring a low settle out pressure.

With this insulated pipe design and operation, U values in the range 0.2 to 0.5 watts per square meter per degree Kelvin are achievable. At these levels, significant improvements in oil and gas transport are available.

An important feature of piping system 10 is its operation in the in the event a leak forms and the pressure in space 20 rises to atmospheric pressure. Because aerogel insulation 16 itself provides good insulation at atmospheric pressure, sections of system 10 will still exhibit a U value in the range of about 0.5 to 1.0 watts per square meter per degree Kelvin in this situation. This is adequate for continuing fluid transportation operations in the majority of cases and does not necessitate an immediate shut down and repair of the pipeline.

Another advantage of this design is that no gettering material is required in space 20. This avoids the complexity of installing the material, and the associated high temperature activation heating required for its operation.

In another example, warm fluid 14 is a high pressure saturated steam having an operating temperature of about 650° F. and a pressure of about 2200 psia. An aerogel insulation 16 with suitable operating temperature is necessary to withstand the temperature of the steam and of the inner pipe 12. One suitable insulation is the Pyrogel™ 5400 series available from Aspen Aerogels, Inc.

The foregoing description has been limited to a specific embodiment of the invention. It will be apparent, however, that variations and modifications can be made to the invention, with the attainment of some or all of the advantages of the invention. Therefore, it is the object of the appended claims to cover all such variations and modifications as come within the true spirit and scope of the invention.

What is claimed is:

1. An assured flow conduit comprising:
an inner conduit having an inner diameter sized to accommodate a flow of warm fluid and an outer diameter, said inner conduit being formed from a material having a low hydrogen content;
an outer conduit enclosing said inner conduit and having an inner diameter larger than the outer diameter of the inner conduit and defining a space therebetween, said space being evacuated to a settle-out pressure; and
an insulating sleeve interposed between said inner conduit and said outer conduit and within said space, wherein said sleeve is formed from an aerogel.

2. The assured flow conduit of claim 1, wherein said settle-out pressure is elevated above an initial evacuation pressure as a result of outgassing from said conduits.

3. The assured flow conduit of claim 2, wherein said initial evacuation pressure is about 0.01 Torr.

4. The assured flow conduit of claim 2 wherein said settle-out pressure is less than about 100 Torr.

5. The assured flow conduit of claim 4 wherein said settle-out pressure is less than about 50 Torr.

6. The assured flow conduit of claim 1, wherein said insulating sleeve is formed about the exterior of said inner pipe.

7. The assured flow conduit of claim 6, wherein said sleeve has a thickness less than the thickness of said space such that the space extends beyond said insulating sleeve.

8. The assured flow pipe of claim 1, wherein the temperature of the warm fluid is between about 32 degrees Fahrenheit and about 390 degrees Fahrenheit.

9. The assured flow pipe of claim 1, wherein the inner pipe material is a steel having a hydrogen content of below about 3 parts per million by weight

10. The assured flop pipe of claim 9 wherein the inner pipe material is a steel having a hydrogen content of below about 1 part per million by weight.

11. The assured flow pipe of claim 1 wherein said aerogel has a thermal conductivity of about 12.5 milliwatts per meter per degree Kelvin at ambient conditions.

12. The assured flow pipe of claim 1 wherein said warm liquid is heavy crude oil.

13. The assured flow pipe of claim 1 wherein the warm liquid comprises a wet natural gas.

14. The assured flow pipe of claim 1, wherein the warm liquid comprises a saturated steam.

15. The assured flow pipe of claim 1, wherein said insulating sleeve provides adequate insulation to accommodate a flow of warm fluid even when the pressure in said space approaches atmospheric pressure.

16. A method of transporting a flow of warm fluid comprising:
providing an inner conduit having an inner diameter sized to accommodate a flow of warm fluid and an outer diameter, said inner conduit being formed from a material having a low hydrogen content;
providing an outer conduit enclosing said inner conduit and having an inner diameter larger than the outer diameter of the inner conduit and defining a space there between,
providing an insulating sleeve interposed between said inner conduit and said outer conduit and within said space, wherein said sleeve is formed from an aerogel.
reducing a pressure within said space to an evacuated level; and
permitting said pressure to rise to a settle-out level.

17. The method of claim 16, wherein said evacuated level is about 0.01 Torr.

18. The method of claim 16, wherein said settle-out level is less than about 100 Torr.

19. The method of claim 18, wherein said settle-out level is less than about 50 Torr.

20. The method of claim 16, wherein said insulating sleeve is formed about the exterior of said inner pipe.

21. The method of claim 20, wherein said sleeve has a thickness less than the thickness of said space such that the space extends beyond said insulating sleeve.

22. The method of claim 16, wherein the temperature of the warm fluid is between about 32 degrees Fahrenheit and about 390 degrees Fahrenheit.

23. The method of claim 16, wherein the inner pipe material is a steel having a hydrogen content of below about 3 parts per million by weight.

24. The method of claim 23 wherein the inner pipe material is a steel having a hydrogen content of below about 1 part per million by weight.

25. The method of claim 16 wherein said aerogel has a thermal conductivity of about 12.5 milliwatts per meter per degree Kelvin at ambient conditions.

26. The method of claim 16 wherein said warm liquid is heavy crude oil.

27. The method of claim 16 wherein the warn liquid comprises a wet natural gas.

28. The method of claim 16 wherein the warm liquid comprises a saturated steam.

29. The method of claim 16 further comprising maintaining adequate insulation for continuing flow of the fluid when said pressure approaches atmospheric pressure.
